(19) United States
(12) Patent Application Publication
(10) Pub. No.: US 2012/0069884 A1
(43) Pub. Date: Mar. 22, 2012

(54) DIGITAL PHASE DETECTOR AND DIGITAL PHASE-LOCKED LOOP

(75) Inventor: Hiroki Sakurai, Fuchu-shi (JP)

(73) Assignee: KABUSHIKI KAISHA TOSHIBA

(21) Appl. No.: 13/071,569

(22) Filed: Mar. 25, 2011

(30) Foreign Application Priority Data
Sep. 21, 2010 (JP) 2010-211273

(51) Int. Cl. H04B 17/00

(52) U.S. Cl. 375/224

(57) ABSTRACT

According to one embodiment, a digital phase detector includes a chain of delay devices configured to receive a reference signal through a first stage and delay the reference signal at each stage. The phase detector includes a sampler group configured to include a first sampler samples a first signal of N-phase input signals (N is an integer of at least 2) in accordance with the reference signal and a second sampler samples a second signal of N-phase input signals which lags behind the first signal in phase by 2π/N in accordance with an output signal from the first stage of the chain of delay devices. The phase detector includes a detection circuit configured to detect a time difference between an edge of the reference signal and an edge of the first signal based on sampled signals from the sampler group to convert the time difference into a phase difference.

### CROSS-REFERENCE TO RELATED APPLICATIONS

This application is based upon and claims the benefit of priority from Japanese Patent Application No. 2010-211273, filed Sep. 21, 2010; the entire contents of which are incorporated herein by reference.

### FIELD

Embodiments described herein relate generally to a digital phase detector.

### BACKGROUND

A radio communication technique used for mobile phones and the like involves a frequency conversion from a carrier frequency band into a baseband (downconversion) and a frequency conversion in the opposite direction (upconversion). Local oscillation signals generated by a local oscillator are utilized for such frequency conversions. The local oscillator can be implemented by using, for example, a digital phase-locked loop (DPLL). A DPLL typically includes a digitally controlled oscillator (DCO) configured such that the frequency of an oscillation signal from the digitally controlled oscillator is controlled by a digital code, a frequency divider configured to divide the frequency of the oscillation signal, and a digital phase detector configured to output a digital signal indicative of a phase difference between the oscillation signal (the frequency of the oscillation signal has been divided) and a reference signal.

The digital phase detector normally includes a chain of delay devices with a plurality of delay devices cascaded and a plurality of samplers to each of which an output signal from a corresponding one of the stages of the chain of delay devices is input. The oscillation signal is input to the chain of delay devices, and the reference signal is input to a clock terminal of each of a plurality of samplers. Output signals from the plurality of samplers are analyzed to obtain a digital signal indicative of the phase difference between the oscillation signal and the reference signal. The time resolution of such a normal digital phase detector is equal to a delay time in each stage of the chain of delay devices.

Furthermore, a verinier delay line (VDL) has been proposed as a technique for improving the time resolution of the digital phase detector. The digital phase detector based on a VDL further includes a chain of delay devices for the reference signal. The reference signal is input to the chain of delay devices. An output signal from each stage of the chain of delay devices is supplied to the clock terminal of the corresponding one of the samplers. The time resolution of the digital phase detector based on a VDL is equal to the difference in delay time between one stage of this chain of delay devices and one stage of the above-described chain of delay devices. In this case, the digital phase detector is designed such that the delay time in one stage of one of the two chains of delay devices is different from the delay time in one stage of the other chain of delay devices.

The above-described common digital phase detector cannot detect a phase difference at a resolution higher than that corresponding to the delay time in one stage of the chain of delay devices. On the other hand, the digital phase detector based on a VDL requires the chain of delay devices for the reference signal. The additional chain of delay devices increases circuit area and power consumption.

### BRIEF DESCRIPTION OF THE DRAWINGS

FIG. 1 is a block diagram illustrating a digital phase detector according to a first embodiment;

FIG. 2 is a block diagram illustrating a digital phase detector according to a second embodiment;

FIG. 3 is a block diagram illustrating a digital phase detector according to a third embodiment;

FIG. 4A is a diagram illustrating detection of a time difference between the edge of each input signal and the edge of a reference signal in the digital phase detector in FIG. 3;

FIG. 4B is a diagram illustrating detection of the time difference between the edge of the input signal and the edge of the reference signal in the digital phase detector in FIG. 3;

FIG. 5 is a block diagram illustrating a digital phase detector according to a fourth embodiment;

FIG. 6 is a timing chart illustrating a variation in the voltage of an output signal from each stage of a ring oscillator in FIG. 5;

FIG. 7 is a block diagram illustrating a digital phase detector according to a fifth embodiment;

FIG. 8 is a block diagram illustrating a digital phase detector according to a sixth embodiment;

FIG. 9 is a block diagram illustrating a digital phase detector according to a seventh embodiment;

FIG. 10 is a block diagram illustrating a TDC according to an eighth embodiment;

FIG. 11A is a diagram illustrating detection of a time difference between the edge of each input signal and the edge of a reference signal in the FTDC in FIG. 10;

FIG. 11B is a diagram illustrating detection of the time difference between the edge of the input signal and the edge of the reference signal in the FTDC in FIG. 10;

FIG. 12 is a block diagram illustrating a digital phase detector including a TDC according to the eighth embodiment;

FIG. 13 is a diagram illustrating the operation of a phase predictor shown in FIG. 12;

FIG. 14 is a block diagram illustrating a part of a TDC according to a ninth embodiment;

FIG. 15 is a block diagram illustrating a digital phase detector including a TDC according to a ninth embodiment;

FIG. 16 is a block diagram illustrating a digital phase detector according to a tenth embodiment; and

FIG. 17 is a block diagram illustrating a communication apparatus according to an eleventh embodiment.

### DETAILED DESCRIPTION

Embodiments will be described below with reference to the drawings.

In general, according to one embodiment, a digital phase detector includes a chain of delay devices configured to receive a reference signal through a first stage and delay the reference signal at each stage. The phase detector includes a sampler group configured to include a first sampler samples a first signal of N-phase input signals (N is an integer of at least 2) in accordance with the reference signal and a second sampler samples a second signal of N-phase input signals which lags behind the first signal in phase by 2π/N in accordance with an output signal from the first stage of the chain of delay devices. The phase detector includes a detection circuit configured to detect a time difference between an edge of the reference signal and an edge of the first signal based on sampled signals from the sampler group to convert the time difference into a phase difference.

In each of the embodiments, the same elements as or elements similar to those of other embodiments already described are denoted by the same or similar reference numerals. Basically, duplicate descriptions are omitted.

In the description below, detection of a rising edge may be appropriately interchanged with detection of a falling edge. On the other hand, detection of the falling edge may be appropriately interchanged with detection of the rising edge.

### First Embodiment

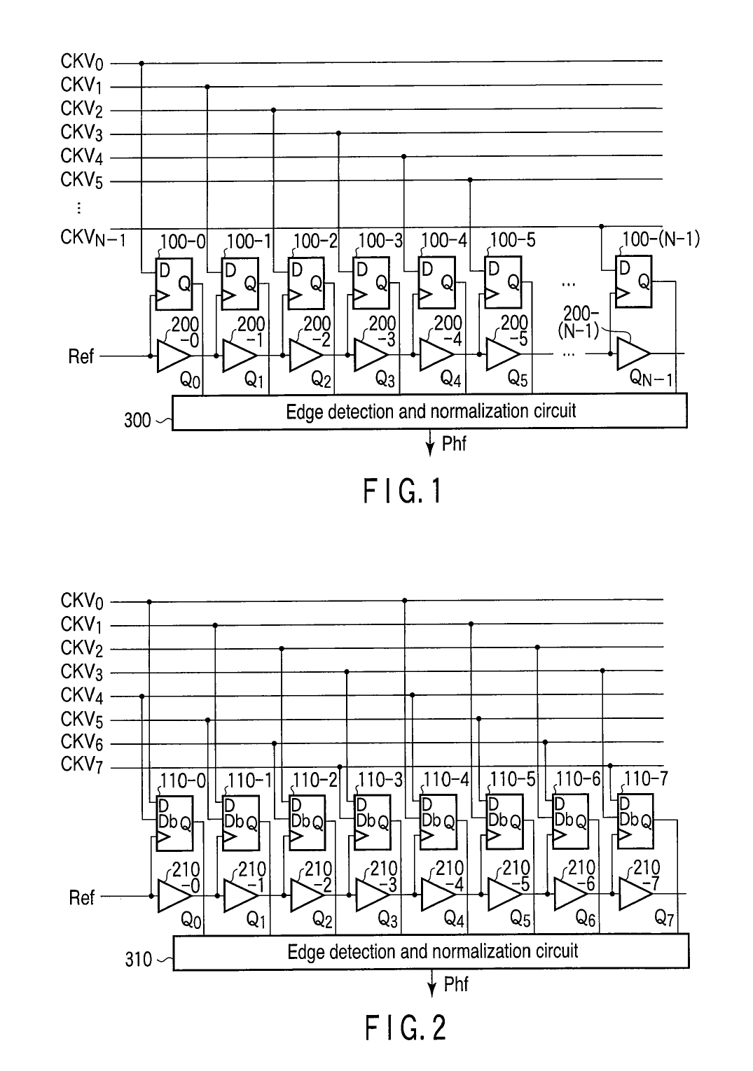

As shown in FIG. 1, a digital phase detector according to a first embodiment includes N (N is an integer of at least 2) samplers 100-0, 100-1, . . . , 100-(N−1), N delay devices 200-0, 200-1, . . . , and 200-(N−1), and an edge detection and normalization circuit 300. In the present embodiment, samplers 100-0, 100-1, . . . , and 100-(N−1) are sometimes collectively referred to as a sampler group 100.

N-phase input signals CKV₀, CVK₁, . . . , and CKV_{N-1} and a reference signal Ref are input to the digital phase detector in FIG. 1. The digital phase detector in FIG. 1 outputs a digital signal Phf indicative of a phase difference between any of the input signals (for example, CKV₀) and the reference signal Ref. In the present embodiment, the number of input signal phases=the number of delay devices and the number of samplers. However, these numbers may differ.

The N-phase input signals CKV₀, CVK₁, . . . , and CKV_{N-1} are delayed in phase in order by substantially 2π/N. For example, an input signal CKVⱼ₊₁ (here, j is any integer of at least 0 and at most N−2) lags behind an input signal CKVⱼ in phase by substantially 2π/N. The phase difference of 2π/N corresponds to a time difference of Tv/N. Tv denotes the period (that is, the inverse of a frequency) of the N-phase input signals CKV₀, CVK₁, . . . , and CKV_{N-1}.

The N delay devices 200-0, 200-1, . . . , and 200-(N−1) are cascaded to form a chain of delay devices. The reference signal Ref is input to the first stage (delay device 200-0) of the chain of delay devices and delayed by substantially t2 at each stage. For example, an output signal from the delay device 200-(N−2) lags behind the reference signal Ref in time by substantially (N−1)·t2. The digital phase detector is designed such that t2 and Tv/N differ. However, which of these values is greater or smaller does not matter.

Samplers 100-0, 100-1, . . . , and 100(N−1) are typically D flip-flops or similar elements. The reference signal Ref is supplied to a clock terminal of sampler 100-0. Input signal CKV₀ is supplied to a D terminal of sampler 100-0. Sampler 100-0 samples input signal CKV₀ in accordance with a clock signal. Sampler 100-0 then outputs input signal CKV₀ to the edge detection and normalization circuit 300 through a Q terminal. An output signal from a delay device 200-i is supplied to a clock terminal of a sampler 100-(i+1). Input signal CKVᵢ₊ₗ is supplied to a D terminal of sampler 100-(i+1). Here, i denotes any integer of at least 0 and at most N−2. Sampler 100-(i+1) samples input signal CKVᵢ₊₁ in accordance with the clock signal. Sampler 100-(i+1) outputs input signal CKVᵢ₊₁ to the edge detection and normalization circuit 300 through a Q terminal.

The edge detection and normalization circuit 300 detects time difference td₀ between the rising edge of the reference signal Ref and the rising edge of input signal CKV₀ preceding the rising edge of the reference signal Ref based on an input signal sequence Q₀, Q₁, . . . , and Q_{N-1} from sampler group 100. Specifically, the edge detection and normalization circuit 300 detects time difference td₀ by analyzing positions in the input signal sequence where 1 changes to 0 (or 0 changes to 1).

The edge detection and normalization circuit 300 normalizes the detected time difference td₀ into a phase difference to obtain a digital signal Phf. For example, the edge detection and normalization circuit 300 further detects time difference td′₀ between the rising edge of the reference signal Ref and the falling edge of input signal CKV₀ preceding the rising edge of the reference signal Ref based on an input signal sequence Q₀, Q₁, . . . , and Q_{N-1}. The edge detection and normalization circuit 300 detects time difference td′₀ by analyzing positions in the input signal sequence where 0 changes to 1 (or 1 changes to 0). The difference between time difference td′₀ and time difference td₀ corresponds to Tv/2. Thus, the period Tv can be derived by doubling the difference between time difference td′₀ and time difference td₀. The edge detection and normalization circuit 300 divides (normalizes) the detected time difference td₀ by the period Tv to convert the detected time difference td₀ into the phase difference. The edge detection and normalization circuit 300 outputs the digital signal Phf for every period of the reference signal Ref.

As described above, sampler group 100 samples input signals lagging behind one another in time by Tv/N in accordance with clock signals lagging behind one another in time by t2. That is, the digital phase detector in FIG. 1 achieves operations similar to those of a VDL. Hence, the time resolution of the digital phase detector in FIG. 1 is equal to the difference between unit delay Tv/N of the input signal and unit delay t2 of the reference signal Ref.

As described above, the digital phase detector according to the first embodiment utilizes, as the delay, the phase difference between multi-phase input signals to achieve operations similar to those of a VDL without the need for the chain of delay devices for the input signal. Thus, the digital phase detector according to the present embodiment allows saving of power consumption and the circuit area corresponding to the chain of delay devices for the input signal, while achieving a high time resolution similar to that of a VDL.

### Second Embodiment

As shown in FIG. 2, a digital phase detector according to a second embodiment includes eight samplers 110-0, 110-1, . . . , and 110-7, eight delay devices 210-0, 210-1, . . . , and 210-7, and an edge detection and normalization circuit 310.

Eight-phase input signals CKV₀, CVK₁, . . . , and CKV₇ and a reference signal Ref are input to the digital phase detector in FIG. 2. The digital phase detector in FIG. 2 outputs a digital signal Phf indicative of a phase difference between any of the input signals (for example, CKV₀) and the reference signal Ref. In the present embodiment, for simplification, the digital phase detector is designed such that the number of input signal phases=the number of delay devices and the number of samplers=8. However, of course, these numbers may be generalized to N (however, in the present embodiment, the number of input signal phases is even). Moreover, in the present embodiment, the number of input signal phases=the number of delay devices and the number of samplers. However, these numbers may differ.

The 8-phase input signals CKV₀, CVK₁, . . . , and CKV₇ are delayed in phase in order by substantially π/4. For example, an input signal CKVⱼ₊₁ (here, j is any integer of at least 0 and at most 6) lags behind an input signal CKVⱼ in phase by substantially π/4. The phase difference of π/4 corresponds to a time difference of Tv/8. Tv denotes the period of the 8-phase input signals CKV₀, CVK₁, . . . , and CKV₇. Moreover, an input signal CKVⱼ₊₄ (or an input signal CKVⱼ₋₄) corresponds to a reverse-phase signal of input signal CKVⱼ. Additionally, when the number of input signal phases is generalized, the reverse-phase signal of input signal CKVⱼ is an input signal CKV_{j+N/2} (or an input signal CKV_{j-N/2}).

The delay devices 210-0, 210-1, . . . , and 210-7 are cascaded to form a chain of delay devices. The reference signal Ref is input to the first stage (delay device 210-0) of the chain of delay devices and delayed by substantially t2 at each stage. For example, an output signal from the delay device 210-6 lags behind the reference signal Ref in time by substantially 7·t2. The digital phase detector is designed such that t2 and Tv/8 differ. However, which of these values is greater or smaller does not matter.

Samplers 110-0, 110-1, . . . , and 110-7 are typically D flip-flops of a differential configuration or similar elements. The reference signal Ref is supplied to a clock terminal of sampler 110-0. Input signal CKV₀ is supplied to a D terminal of sampler 110-0. Input signal CKV₄ is supplied to a Db terminal of sampler 110-0. Sampler 110-0 samples the differential signal between input signal CKV₀ and input signal CKV₄ (that is, the reverse-phase signal of input signal CKV₀) in accordance with a clock signal. Sampler 110-0 then outputs the sampled signal to the edge detection and normalization circuit 310 through a Q terminal. An output signal from a delay device 210-i is supplied to a clock terminal of a sampler 110-(i+1). Input signal CKVᵢ₊₁ is supplied to a D terminal of sampler 110-(i+1). An input signal CKVᵢ₊₅ (or CKVᵢ₋₋₃) is supplied to a Db terminal of a sampler 110-(i+1). Here, i denotes any integer of at least 0 and at most 6. Sampler 110-(i+1) samples the differential signal between input signal CKVᵢ₊₁ and CKVᵢ₊₅ (or CKVᵢ₋₃) in accordance with the clock signal. Sampler 110-(i+1) outputs the sampled signal to the edge detection and normalization circuit 310 through a Q terminal.

Like the edge detection and normalization circuit 300, the edge detection and normalization circuit 310 detects time difference td₀ based on an input signal sequence Q₀, Q₁, . . . , Q₇ from sampler group 110. Moreover, like the edge detection and normalization circuit 300, the edge detection and normalization circuit 310 normalizes the detected time difference td₀ into a phase difference to obtain a digital signal Phf. The edge detection and normalization circuit 310 outputs the digital signal Phf for every period of the reference signal Ref.

As described above, sampler group 110 samples input signals (the differential signal between the input signals) lagging behind one another in time by Tv/8 in accordance with clock signals lagging behind one another in time by t2. That is, the digital phase detector in FIG. 2 achieves operations similar to those of a VDL. Hence, the time resolution of the digital phase detector in FIG. 2 is equal to the difference between unit delay Tv/8 of the input signal and unit delay t2 of the reference signal Ref.

As described above, the digital phase detector according to the second embodiment corresponds to the digital phase detector according to the first embodiment configured to sample the differential input signal. Thus, the digital phase detector according to the present embodiment can provide effects similar to those of the digital phase detector according to the first embodiment. Furthermore, the differential configuration of the digital phase detector according to the present embodiment serves to give various advantages (a common mode rejection effect and the like).

### Third Embodiment

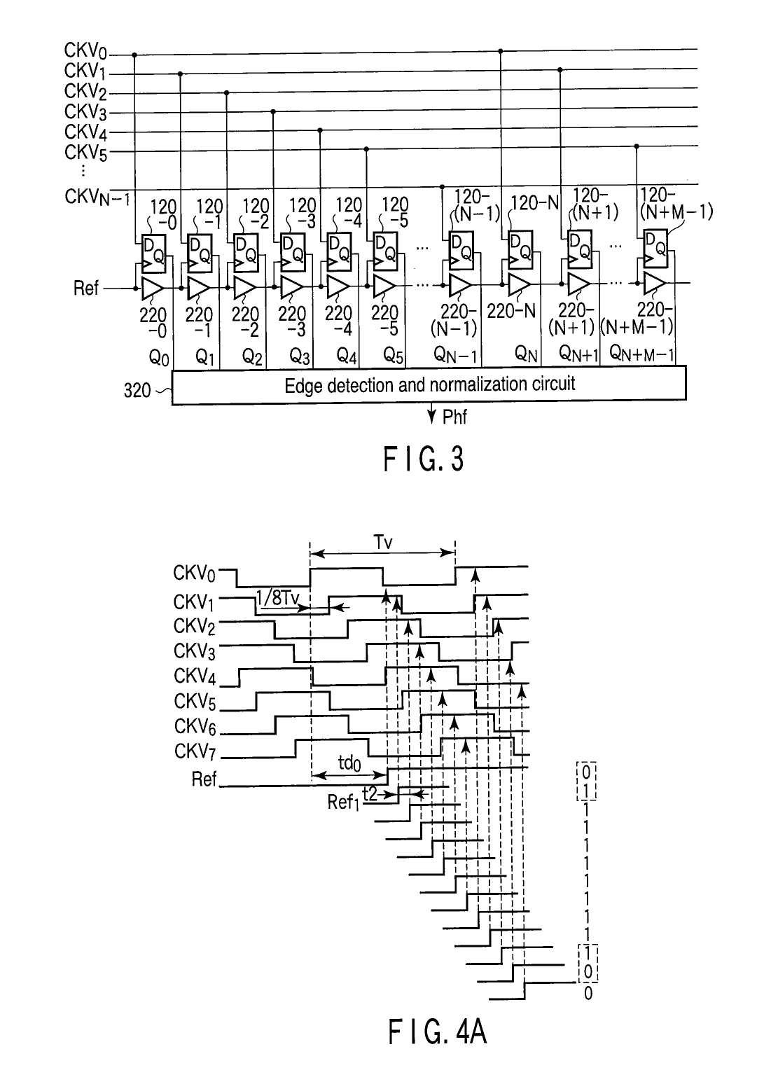

As shown in FIG. 3, a digital phase detector according to a third embodiment includes N+M (N is an integer of at least 2, and M is an integer of at least 1) samplers 120-0, 120-1, . . . , 120-(N+M−1), N+M delay devices 220-0, 220-1, . . . , and 220-(N+M−1), and an edge detection and normalization circuit 320. In the present embodiment, samplers 120-0, 120-1, . . . , and 120-(N−1) are sometimes collectively referred to as a sampler group 120.

N-phase input signals CKV₀, CVK₁, . . . , and CKV_{N-1} and a reference signal Ref are input to the digital phase detector in FIG. 3. The digital phase detector in FIG. 3 outputs a digital signal Phf indicative of a phase difference between any of the input signals (for example, CKV₀) and the reference signal Ref.

The delay devices 220-0, 220-1, . . . , and 220-(N+M−1) are cascaded to form a chain of delay devices. The reference signal Ref is input to the first stage (delay device 220-0) of the chain of delay devices and delayed by substantially t2 at each stage. For example, an output signal from the delay device 220-(N+M−2) lags behind the reference signal Ref in time by substantially (N+M−1)·t2. The digital phase detector is designed such that t2 and Tv/N differ. However, which of these values is greater or smaller does not matter.

Samplers 120-0, 120-1, . . . , and 120(N+M−1) are typically D flip-flops or similar elements. The reference signal Ref is supplied to a clock terminal of sampler 120-0. Input signal CKV₀ is supplied to a D terminal of sampler 120-0. Sampler 120-0 samples input signal CKV₀ in accordance with a clock signal. Sampler 120-0 then outputs input signal CKV₀ to the edge detection and normalization circuit 320 through a Q terminal.

An output signal from a delay device 220-i is supplied to a clock terminal of a sampler 120-(i+1). Input signal CKVᵢ₊₁ is supplied to a D terminal of sampler 120-(i+1). Here, i denotes any integer of at least 0 and at most (N+M−2).

However, if i+1≧N, the value of i+1 exceeds the number of input signal phases. Thus, for example, input signal CKV₀ is supplied to a D terminal of a sampler 120-N. Subsequently, from i+1=N to 2N, an input signal CKV_{(i+1)-N} is supplied to the D terminal of sampler 120-(i+1). In general terms, an input signal CKV_{(i+1)modN} is input to the D terminal of sampler 120-(i+1). “xmody” means the remainder of x modulo y.

Additionally, for example, input signal CKV₀ can be considered to lag behind an input signal CKV_{N-1} supplied to a D terminal of a sampler 120-(N−1), in time by Tv/N. Hence, even for i+1≧N, the relationship is maintained in which the input signals supplied to the D terminal of the sampler lag behind one another in time by substantially Tv/N.

Sampler 120-(i+1) samples input signal CKV_{(i+1)modN} in accordance with the clock signal. Sampler 120-(i+1) outputs input signal CKV_{(i+1)modN} to the edge detection and normalization circuit 320 through a Q terminal. In addition, if N is even, sampler group 120 may sample differential input signals.

Like the edge detection and normalization circuit 300, the edge detection and normalization circuit 320 detects time difference td₀ based on an input signal sequence Q₀, Q₁, . . . , and Q_{N+M-1} from sampler group 120. Moreover, like the edge detection and normalization circuit 300, the edge detection and normalization circuit 320 normalizes the detected time difference td₀ into a phase difference to obtain a digital signal Phf. The edge detection and normalization circuit 320 outputs the digital signal Phf for every period of the reference signal Ref.

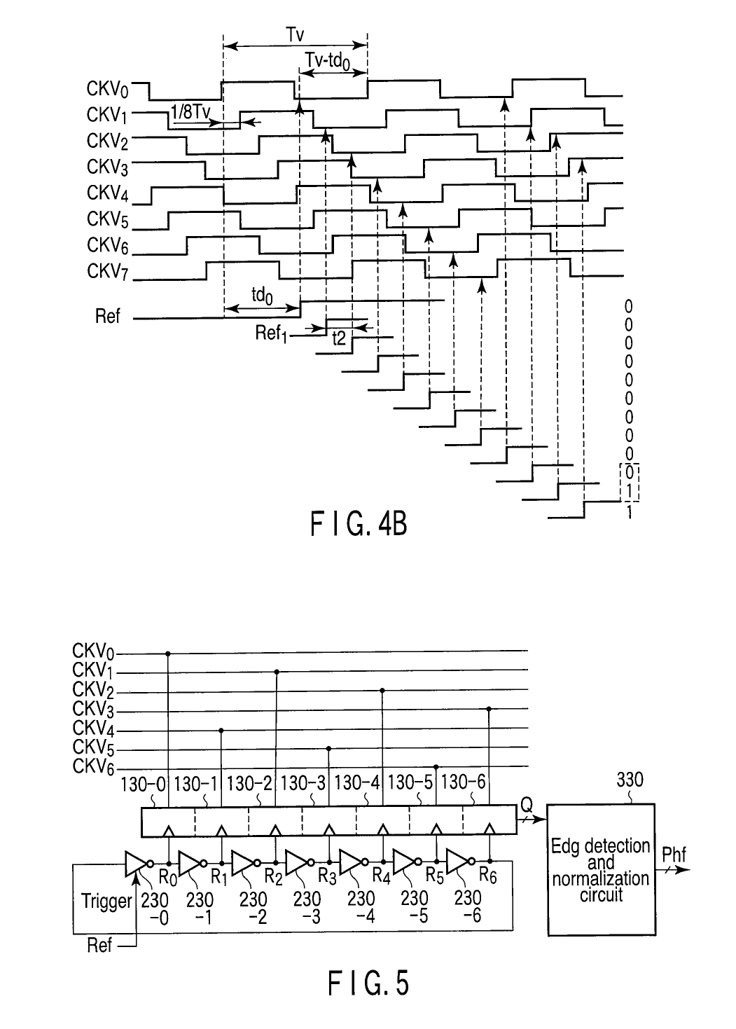

For example, for N=8, detection of the time difference between input signal CKV₀ and the reference signal Ref is carried out as shown in FIG. 4A or FIG. 4B. FIG. 4A corresponds to the case of Tv/8<t2. FIG. 4B corresponds to the case of Tv/8>t2. For convenience, the time difference between the rising edge of a delayed reference signal Refᵢ₊₁ supplied to sampler 120(i+1) and the rising edge of the CKV_{(i+1)modN} preceding the rising edge of the delayed reference signal Refᵢ₊₁ is hereinafter denoted by tdᵢ₊₁.

In the example illustrated in FIG. 4A, time difference tdᵢ₊₁=td₀-i·(Tv/8−t2). The value of time difference td₀ quantized by (Tv/8−t2) can be obtained by detecting a position where time difference tdᵢ₊₁ changes from a positive value to a negative value (that is, the input signal sequence Q₀, Q₁, . . . , and Q_{N+M-1} changes from 1 to 0). Moreover, the value of time difference td′₀ quantized by (Tv/8−t2) can be obtained by detecting a position where time difference tdᵢ₊₁ is smaller than Tv/2 (or −Tv/2) (that is, the input signal sequence Q₀, Q₁, . . . , and Q_{N+M-1} changes from 0 to 1).

In the example illustrated in FIG. 4B, time difference tdᵢ₊₁=td₀+i·(t2−Tv/8). The value of the (Tv−td₀) quantized by (t2−Tv/8) can be obtained by detecting a position where time difference tdᵢ₊₁ is greater than the period Tv (that is, the input signal sequence Q₀, Q₁, . . . , and Q_{N+M-1} changes from 0 to 1). Thus, the value of time difference td₀ quantized by (t2−Tv/8) can be obtained by subtracting the above-described quantized value from Tv. Moreover, the value of (Tv-td′₀) quantized by (Tv/8−t2) can be obtained by detecting a position where time difference tdᵢ₊₁ is greater than Tv/2 (or 3Tv/2) (that is, the input signal sequence Q₀, Q₁, . . . , and Q_{N+M-1} changes from 1 to 0). Thus, the value of time difference td′₀ quantized by (t2−Tv/8) can be obtained by subtracting the above-described quantized value from Tv.

As described above, sampler group 120 samples input signals lagging behind one another in time by Tv/N in accordance with clock signals lagging behind one another in time by t2. That is, the digital phase detector in FIG. 3 achieves operations similar to those of a VDL. Hence, the time resolution of the digital phase detector in FIG. 3 is equal to the difference between unit delay Tv/N of the input signal and unit delay t2 of the reference signal Ref.

As described above, the digital phase detector according to the third embodiment permits samplers that are greater than the input signal phases in number. Therefore, the digital phase detector according to the present embodiment, greater time differences (up to (N+M) times as great as the time resolution) can be detected.

### Fourth Embodiment

As shown in FIG. 5, a digital phase detector according to a fourth embodiment includes seven samplers 130-0, 130-1, . . . , and 130-6, seven delay devices 230-0, 230-1, . . . , and 230-6, and an edge detection and normalization circuit 330. In the present embodiment, samplers 130-0, 130-1, . . . , and 130-6 are sometimes collectively referred to as a sampler group 130.

Seven-phase input signals CKV₀, CVK₁, . . . , and CKV₆ and a reference signal Ref are input to the digital phase detector in FIG. 5. The digital phase detector in FIG. 5 outputs a digital signal Phf indicative of a phase difference between any of the input signals (for example, CKV₀) and the reference signal Ref. In the present embodiment, for simplification, the digital phase detector is designed such that the number of input signal phases=the number of delay devices and the number of samplers=7. However, of course, these numbers may be generalized to N (however, in the present embodiment, the number of delay devices and the number of samplers are odd). Moreover, in the present embodiment, the number of input signal phases=the number of delay devices and the number of samplers. However, these numbers may differ.

The 7-phase input signals CKV₀, CVK₁, . . . , and CKV₆ are delayed in phase in order by substantially 2π/7. For example, an input signal CKVⱼ₊₁ (here, j is any integer of at least 0 and at most 5) lags behind an input signal CKVⱼ in phase by substantially 2π/7. The phase difference of 2π/7 corresponds to a time difference of Tv/7. Tv denotes the period of the 7-phase input signals CKV₀, CVK₁, . . . , and CKV₆.

The delay devices 230-0, 230-1, . . . , and 230-6 are typically single-phase inverters. The delay devices are annularly connected together to function as a (7-phase) ring oscillator. In the following description, the delay devices 230-0, 230-2, . . . , and 230-6 are sometimes collectively referred to as a ring oscillator 230.

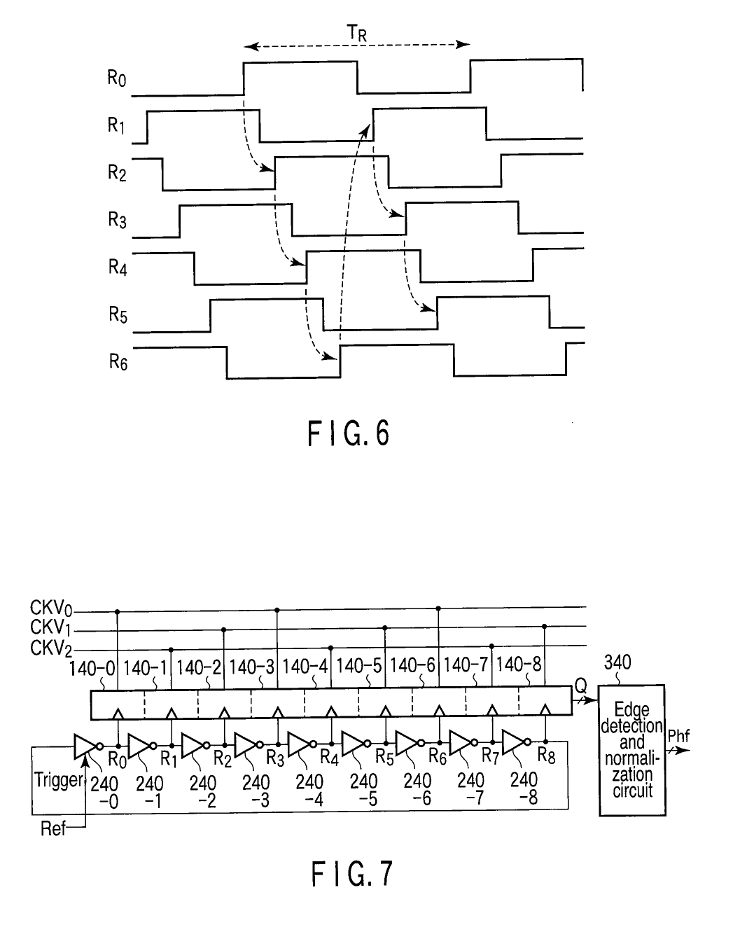

The ring oscillator 230 utilizes the reference signal Ref as a trigger. That is, when the reference signal Ref changes from low (0) to high (1), the ring oscillator 230 oscillates starting with the delay device 230-0. A delay device 230-(i+1) inverts an input signal from a delay device 230-i and then outputs the inverted signal. Here, i is any integer of at least 0 and at most 5. Moreover, the signal is delayed by substantially T_{R}/14 upon passing through the delay device 230-(i+1). T_{R} denotes the oscillation period of the ring oscillator 230. That is, an output signal Rᵢ₊₁ from the delay device 230-(i+1) lags behind an input signal Rᵢ to the delay device 230-(i+1) in time by substantially 4T_{R}/7. FIG. 6 illustrates a variation in the voltage of an output signal from each stage of the ring oscillator 230. As is apparent from FIG. 6, the output signal from each stage of the ring oscillator 230 is delayed by T_{R}/7 in order of R₀→R_{2→R}_{4→R}₆→R₁→R₃→R₅→R₀→+ . . . . The digital phase detector is designed such that T_{R}/7 and Tv/7 differ. However, which of these values is greater or smaller does not matter.

The oscillation period of the ring oscillator 230 is counted by a counter (not shown in the drawings). For example, when the t-th (t is a number of at least 1) oscillation period is completed, the ring oscillator 230 stops oscillation. Hence, the sampler group 130 can sample a total of 7×t points. That is, the ring oscillator 230 can be considered to be 7×t delay devices. Sampler group 130 can be considered to be 7×t samplers. Furthermore, before the t-th oscillation period is completed, the ring oscillator may stop oscillation provided that the edge detection and normalization circuit 330 detects the desired time difference td₀ (and td′₀).

Samplers 130-0, 130-1, . . . , and 130-6 utilizes output signals from the delay devices 230-0, 230-1, . . . , and 230-6, respectively, as clock signals to sample input signals. The signals sampled by samplers 130-0, 130-1, . . . , and 130-6 are determined by the order in which the clock signals are delayed. That is, sampler 130-0, which utilizes clock signal R₀ with the shortest delay, samples input signal CKV₀ with the shortest delay. On the other hand, sampler 130-5, which utilizes clock signal R₅ with the longest delay, samples input signal CKV₆ with the longest delay. Sampler group 130 inputs sampled signals to the edge detection and normalization circuit 330.

The edge detection and normalization circuit 330 detects time difference td₀ between the rising edge of the reference signal Ref and the rising edge of input signal CKV₀ preceding the rising edge of the reference signal Ref based on an input signal sequence Q₀, Q₁, . . . , and Q₆ from sampler group 130.

Specifically, a technique similar to that for the edge detection and normalization circuit 300 can be applied to the edge detection and normalization circuit 330 by sorting the input signal sequence Q₀, Q₁, . . . , and Q₆ in order of Q₀→Q₂→Q₄→Q₆→Q₁→Q₃→Q₅→Q₀→ . . . corresponding to the order of the delay. Provided that t is at least 2, the edge detection and normalization circuit 330 may detect edges in order starting with the input signal sequence during the first oscillation period. Moreover, like the edge detection and normalization circuit 300, the edge detection and normalization circuit 330 normalizes the detected time difference td₀ into a phase difference to obtain a digital signal Phf. The edge detection and normalization circuit 330 outputs the digital signal Phf for every period of the reference signal Ref.

As described above, sampler group 130 samples input signals lagging behind one another in time by Tv/7 in accordance with clock signals lagging behind one another in time by T_{R}/7. That is, the digital phase detector in FIG. 5 achieves operations similar to those of a VDL. Hence, the time resolution of the digital phase detector in FIG. 5 is equal to the difference between unit delay Tv/7 of the input signal and unit delay T_{R}/7 of the reference signal Ref.

As described above, the digital phase detector according to the fourth embodiment oscillates the ring oscillator for up to t periods to generate delayed clock signals. Thus, the digital phase detector according to the present embodiment can provide effects similar to those provided by a configuration with (the number of phases of the ring oscillator×t) samplers and (the number of phases of the ring oscillator×t) delay devices provided therein.

### Fifth Embodiment

As shown in FIG. 7, a digital phase detector according to a fifth embodiment includes nine samplers 140-0, 140-1, . . . , and 140-8, nine delay devices 240-0, 240-1, . . . , and 240-8, and an edge detection and normalization circuit 340. In the present embodiment, samplers 140-0, 140-1, . . . , and 140-8 are sometimes collectively referred to as a sampler group 140.

3-phase input signals CKV₀, CVK₁, and CKV₂ and a reference signal Ref are input to the digital phase detector in FIG. 7. The digital phase detector in FIG. 7 outputs a digital signal Phf indicative of a phase difference between any of the input signals (for example, CKV₀) and the reference signal Ref. In the present embodiment, for simplification, the digital phase detector is designed such that the number of input signal phases×3=the number of delay devices and the number of samplers=9. However, of course, the number of input signal phases may be generalized to N, and the number of delay devices and the number of samplers may be generalized to odd multiples of N.

The 3-phase input signals CKV₀, CVK₁, and CKV₂ are delayed in phase in order by substantially 2π/3. For example, an input signal CKVⱼ₊₁ (here, j is 0 or 1) lags behind an input signal CKVⱼ in phase by substantially 2π/3. The phase difference of 2π/3 corresponds to a time difference of Tv/3. Tv denotes the period of the 3-phase input signals CKV₀, CVK₁, and CKV₂.

The delay devices 240-0, 240-1, . . . , and 240-8 are typically single-phase inverters. The delay devices are annularly connected together to function as a 9-phase ring oscillator. In the following description, the delay devices 240-0, 240-1, . . . , and 240-8 are sometimes collectively referred to as a ring oscillator 240.

The ring oscillator 240 utilizes the reference signal Ref as a trigger. That is, when the reference signal Ref changes from low (0) to high (1), the ring oscillator 240 oscillates starting with the delay device 240-0. A delay device 240-(i+1) inverts an input signal from a delay device 240-i and then outputs the inverted signal. Here, i is any integer of at least 0 and at most 7. Moreover, the signal is delayed by substantially T_{R}/18 upon passing through the delay device 240-(i+1). T_{R} denotes the oscillation period of the ring oscillator 240. That is, an output signal Rᵢ₊₁ from the delay device 240-(i+1) lags behind an input signal Rᵢ to the delay device 240-(i+1) in time by substantially 5T_{R}/9. Thus, the output signal from each stage of the ring oscillator 240 is delayed by T_{R}/9 in order of R₀→R₂→R₄→R₆→R₈→R₁→R₃→R₅→R₇→R₀→ . . . The digital phase detector is designed such that T_{R}/9 and Tv/3 differ. However, which of these values is greater or smaller does not matter.

Like the ring oscillator 230, the ring oscillator 240 oscillates for up to t periods. Hence, the sampler group 140 can sample a total of 9×t points. That is, the ring oscillator 240 can be considered to be 9×t delay devices. Sampler group 140 can be considered to be 9×t samplers.

Samplers 140-0, 140-1, . . . , and 140-8 utilizes output signals from the delay devices 240-0, 240-1, . . . , and 240-8, respectively, as clock signals to sample input signals. The signals sampled by samplers 140-0, 140-1, . . . , and 140-8 are determined by the order in which the clock signals are delayed. That is, sampler 140-0, which utilizes clock signal R₀ with the shortest delay, samples input signal CKV₀ with the shortest delay. On the other hand, sampler 140-2, which utilizes clock signal R₂ with the second shortest delay, samples input signal CKV₁ with the second shortest delay.

In the present embodiment, the number of input signal phases is smaller than the number of samplers. However, since the input signal is delayed in order of CKV₀→CKV₁→CKV₂→CKV₀ . . . , the signals to be sampled by the samplers can be determined by this order. For example, sampler 140-6, which utilizes clock signal R₆ with the fourth shortest delay, samples input signal CKV₀ with the fourth shortest delay. Sampler group 140 inputs sampled signals to the edge detection and normalization circuit 340.

The edge detection and normalization circuit 340 detects time difference td₀ between the rising edge of the reference signal Ref and the rising edge of input signal CKV₀ preceding the rising edge of the reference signal Ref based on an input signal sequence Q₀, Q₁, . . . , and Q₈ from sampler group 140. Specifically, a technique similar to that for the edge detection and normalization circuit 300 can be applied to the edge detection and normalization circuit 340 by sorting the input signal sequence Q₀, Q₁, . . . , and Q₈ in order of Q₀→Q₂→Q₄→Q₆→Q₈→Q₁→Q₃→Q₅→Q₇→Q₀→ . . . corresponding to the order of the delay. Provided that t is at least 2, the edge detection and normalization circuit 340 may detect edges in order starting with the input signal sequence during the first oscillation period. Moreover, like the edge detection and normalization circuit 300, the edge detection and normalization circuit 340 normalizes the detected time difference td₀ into a phase difference to obtain a digital signal Phf. The edge detection and normalization circuit 340 outputs the digital signal Phf for every period of the reference signal Ref.

As described above, sampler group 140 samples input signals lagging behind one another in time by Tv/3 in accordance with clock signals lagging behind one another in time by T_{R}/9. That is, the digital phase detector in FIG. 7 achieves operations similar to those of a VDL. Hence, the time resolution of the digital phase detector in FIG. 7 is equal to the difference between unit delay Tv/3 of the input signal and unit delay T_{R}/9 of the reference signal Ref.

As described above, the digital phase detector according to the fifth embodiment utilizes the samplers and delay devices the numbers of which are greater than that of the input signal phases. Thus, the digital phase detector according to the present embodiment allows the samplers and the delay devices to operate at low speeds (at low frequencies) with respect to the frequency of the input signal.

### Sixth Embodiment

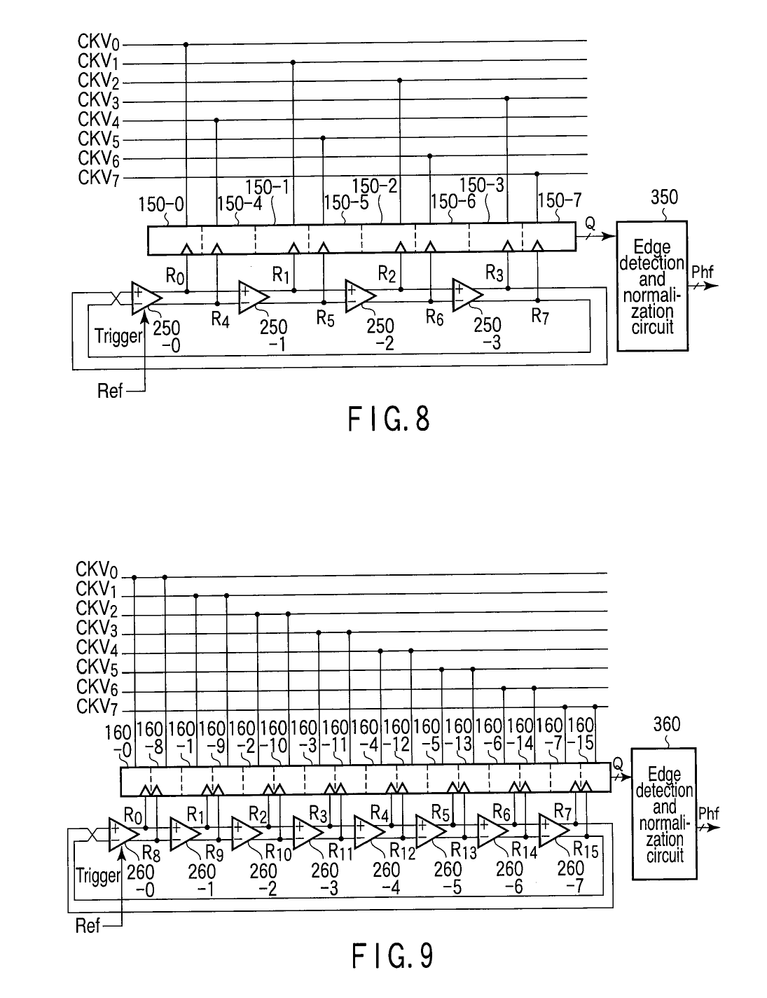

As shown in FIG. 8, a digital phase detector according to a sixth embodiment includes eight samplers 150-0, 150-1, . . . , and 150-7, four delay devices 250-0, 250-1, . . . , and 250-3, and an edge detection and normalization circuit 350. In the present embodiment, samplers 150-0, 150-1, . . . , and 150-7 are sometimes collectively referred to as a sampler group 150.

Eight-phase input signals CKV₀, CVK₁, . . . , and CKV₇ and a reference signal Ref are input to the digital phase detector in FIG. 8. The digital phase detector in FIG. 8 outputs a digital signal Phf indicative of a phase difference between any of the input signals (for example, CKV₀) and the reference signal Ref. In the present embodiment, for simplification, the digital phase detector is designed such that the number of input signal phases=the number of delay devices×2=the number of samplers=8. However, of course, these numbers may be generalized to N. Moreover, in the present embodiment, the number of input signal phases=the number of delay devices×2=the number of samplers. However, the number of input signal phases may differ from the number of delay devices×2 and from the number of samplers.

The four delay devices 250-0, 250-1, . . . , and 250-3 are typically differential amplifiers. The delay devices are annularly connected together to function as a (8-phase) differential ring oscillator. In the following description, the four delay devices 250-0, 250-1, . . . , and 250-3 are sometimes collectively referred to as a differential ring oscillator 250.

The differential ring oscillator 250 utilizes the reference signal Ref as a trigger. That is, when the reference signal Ref changes from low (0) to high (1), the differential ring oscillator 250 oscillates starting with the delay device 250-0. A delay device 250-(i+1) delays differential input signals Rᵢ and Rᵢ₊₄ from a delay device 250-i by substantially T_{R}/8. The delay device 250-(i+1) supplies differential output signals Rᵢ₊₁ and Rᵢ₊₅ to the next stage. Here, i is any integer of at least 0 and at most 2. T_{R} denotes the oscillation period of the differential ring oscillator 250. That is, the differential output signals Rᵢ₊₁ and Rᵢ₊₅ from the delay device 250-(i+1) lag behind the differential input signals Rᵢ and Rᵢ₊₄ to the delay device 250-(i+1) in time by substantially T_{R}/8. Thus, the output signal from each stage of the differential ring oscillator 250 is delayed by T_{R}/8 in order of R₀→R₁→ . . . →R₇→R₀. . . . The digital phase detector is designed such that T_{R}/8 and Tv/8 differ. However, which of these values is greater or smaller does not matter.

Like the ring oscillator 230, the differential ring oscillator 250 oscillates for up to t periods. Hence, the sampler group 150 can sample a total of 8×t points. That is, the differential ring oscillator 250 can be considered to be 8×t delay devices. Sampler group 150 can be considered to be 8×t samplers.

Samplers 150-0, 150-1, . . . , and 150-7 utilizes output signals from the delay devices 250-0, 250-1, . . . , and 250-3, respectively, as clock signals to sample input signals. Sampler 150-h utilizes signal Rₕ as a clock signal to sample an input signal CKVₕ. In the present embodiment, h is an integer of at least 0 and at most 7. Sampler group 150 inputs sampled signals to the edge detection and normalization circuit 350. Sampler group 150 may sample differential input signals or may be driven by differential clock signals.

Like the edge detection and normalization circuit 300, the edge detection and normalization circuit 350 detects time difference td₀ between the rising edge of the reference signal Ref and the rising edge of input signal CKV₀ preceding the rising edge of the reference signal Ref based on an input signal sequence Q₀, Q₁, . . . , and Q₇ from sampler group 150. Provided that t is at least 2, the edge detection and normalization circuit 350 may detect edges in order starting with the input signal sequence during the first oscillation period. Moreover, like the edge detection and normalization circuit 300, the edge detection and normalization circuit 350 normalizes the detected time difference td₀ into a phase difference to obtain a digital signal Phf. The edge detection and normalization circuit 350 outputs the digital signal Phf for every period of the reference signal Ref.

As described above, sampler group 150 samples input signals lagging behind one another in time by Tv/8 in accordance with clock signals lagging behind one another in time by T_{R}/8. That is, the digital phase detector in FIG. 8 achieves operations similar to those of a VDL. Hence, the time resolution of the digital phase detector in FIG. 8 is equal to the difference between unit delay Tv/8 of the input signal and unit delay T_{R}/8 of the reference signal Ref.

As described above, the digital phase detector according to the sixth embodiment oscillates the differential ring oscillator for up to t periods to generate delayed clock signals. Thus, the digital phase detector according to the present embodiment can provide effects similar to those provided by a configuration with (the number of phases of the differential ring oscillator×t) samplers and (the number of phases of the differential ring oscillator×t) delay devices provided therein.

### Seventh Embodiment

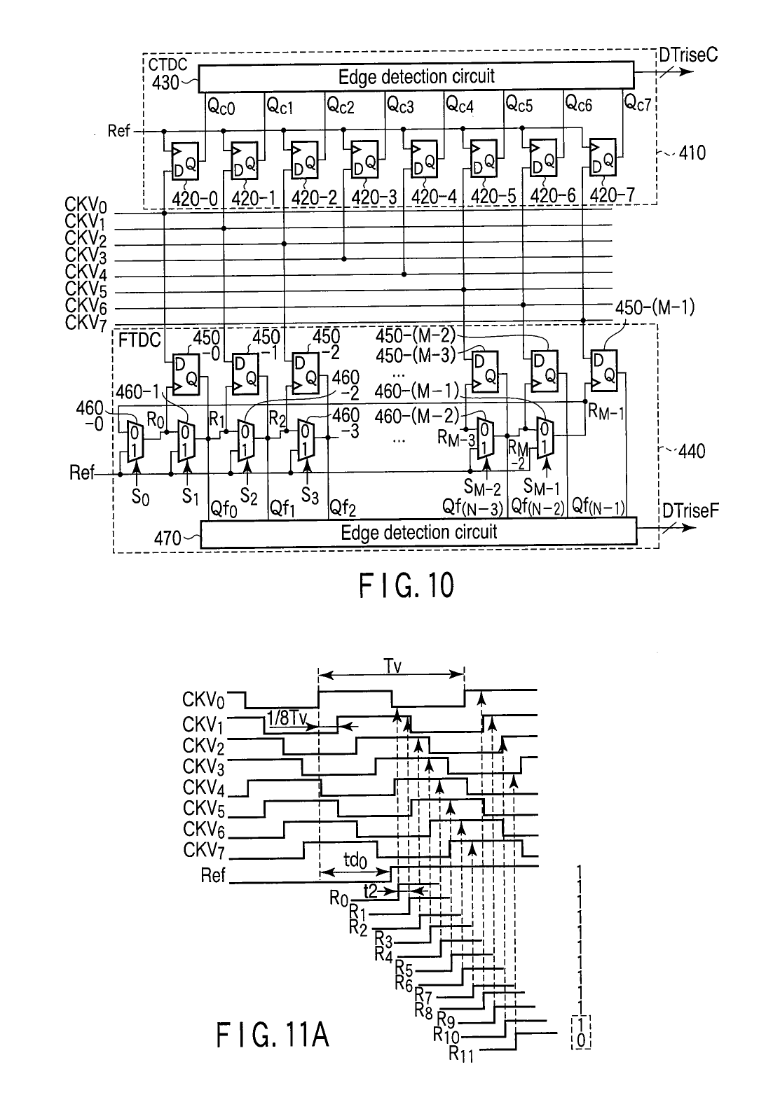

As shown in FIG. 9, a digital phase detector according to a seventh embodiment includes 16 samplers 160-0, 160-1, . . . , and 160-15, eight delay devices 260-0, 260-1, . . . , and 260-7, and an edge detection and normalization circuit 360. In the present embodiment, samplers 160-0, 160-1, . . . , and 160-7 are sometimes collectively referred to as a sampler group 160.

Eight-phase input signals CKV₀, CVK₁, . . . , and CKV₇ and a reference signal Ref are input to the digital phase detector in FIG. 9. The digital phase detector in FIG. 9 outputs a digital signal Phf indicative of a phase difference between any of the input signals (for example, CKV₀) and the reference signal Ref. In the present embodiment, for simplification, the digital phase detector is designed such that the number of input signal phases×2=the number of delay devices×2=the number of samplers=16. However, of course, the number of input signal phases may be generalized to N, and the number of delay devices×2 and the number of samplers may be generalized to integral multiples of N/2.

The four delay devices 260-0, 260-1, . . . , and 260-7 are typically differential amplifiers. The delay devices are annularly connected together to function as a (16-phase) ring oscillator. In the following description, the delay devices 260-0, 260-1, . . . , and 260-7 are sometimes collectively referred to as a differential ring oscillator 260.

The differential ring oscillator 260 utilizes the reference signal Ref as a trigger. That is, when the reference signal Ref changes from low (0) to high (1), the differential ring oscillator 260 oscillates starting with the delay device 260-0. A delay device 260-(i+1) delays differential input signals Rᵢ and Rᵢ₊₈ from a delay device 260-i by substantially T_{R}/16. The delay device 250-(i+1) supplies differential output signals Rᵢ₊₁ and Rᵢ₊₉ to the next stage. Here, i is any integer of at least 0 and at most 6. T_{R} denotes the oscillation period of the differential ring oscillator 260. That is, the differential output signals Rᵢ₊₁ and Rᵢ₊₉ from the delay device 260-(i+1) lag behind the differential input signals Rᵢ and Rᵢ₊₈ to the delay device 260-(i+1) in time by substantially T_{R}/16. Thus, the output signal from each stage of the differential ring oscillator 260 is delayed by T_{R}/16 in order of R₀→R₁→ . . . →R15→R₀→ . . . The digital phase detector is designed such that T_{R}/16 and Tv/8 differ. However, which of these values is greater or smaller does not matter.

Like the ring oscillator 230, the differential ring oscillator 260 oscillates for up to t periods. Hence, the sampler group 160 can sample a total of 16×t points. That is, the differential ring oscillator 260 can be considered to be 16×t delay devices. Sampler group 160 can be considered to be 16×t samplers.

Samplers 160-0, 160-1, . . . , and 160-15 utilizes output signals from the delay devices 260-0, 260-1, . . . , and 260-7, respectively, as clock signals to sample input signals. Sampler 160-h utilizes signal Rₕ as a clock signal to sample an input signal CKVₕ. In the present embodiment, h is an integer of at least 0 and at most 15.

In the present embodiment, the number of input signal phases is smaller than the number of samplers and the number of delay devices×2. However, since the input signal is delayed in order of CKV₀→CKV₁→ . . . →CKV₇→CKV₀→ . . . , the signals to be sampled by samplers 160-0, 160-1, . . . , 160-15 can be determined by this order. For example, sampler 160-8, which utilizes the clock signal R₈ with the ninth shortest delay, samples input signal CKV₀ with the ninth shortest delay. In general terms, sampler 160-h samples an input signal CKV_{hmod8}. Sampler group 160 inputs sampled signals to the edge detection and normalization circuit 360. Sampler group 160 may sample differential input signals or may be driven by differential clock signals.

Like the edge detection and normalization circuit 300, the edge detection and normalization circuit 360 detects time difference td₀ between the rising edge of the reference signal Ref and the rising edge of input signal CKV₀ preceding the rising edge of the reference signal Ref based on an input signal sequence Q₀, Q, . . . , and Q₁₅ from sampler group 160. Provided that t is at least 2, the edge detection and normalization circuit 360 may detect edges in order starting with the input signal sequence during the first oscillation period. Moreover, like the edge detection and normalization circuit 300, the edge detection and normalization circuit 360 normalizes the detected time difference td₀ into a phase difference to obtain a digital signal Phf. The edge detection and normalization circuit 360 outputs the digital signal Phf for every period of the reference signal Ref.

As described above, sampler group 160 samples input signals lagging behind one another in time by Tv/8 in accordance with clock signals lagging behind one another in time by T_{R}/16. That is, the digital phase detector in FIG. 9 achieves operations similar to those of a VDL. Hence, the time resolution of the digital phase detector in FIG. 9 is equal to the difference between unit delay Tv/8 of the input signal and unit delay T_{R}/16 of the reference signal Ref.

As described above, the digital phase detector according to the seventh embodiment utilizes the large number of samplers with respect to the number of input signal phases and the differential ring oscillator with the delay devices that are half the samplers in number. Thus, the digital phase detector according to the present embodiment allows the samplers and the delay devices to operate at low speeds (at low frequencies) with respect to the frequency of the input signal.

### Eighth Embodiment

An eighth embodiment relates to a time-to-digital converter (TDC) included in a digital phase detector. In general, a TDC converts the time difference between the edge of an input signal and the edge of a reference signal into a digital value. As shown in FIG. 10, a TDC according to the present embodiment includes a CTDC 410 with a relatively coarse time resolution and an FTDC 440 with a relatively fine time resolution. Eight-phase input signals CKV₀, CKV₁, . . . , and CKV₇ and a reference signal Ref are input to the TDC in FIG. 10. The TDC in FIG. 10 outputs a digital signal DTriseC indicative of the time difference between any of the input signals (for example, CKV₀) and the reference signal Ref, and a digital signal DTriseF indicative of the time difference between an input signal with a phase that is the same as or different from that of the above-described input signal and the reference signal Ref.

The CTDC 410 includes eight samplers 420-0, 420-1, . . . , 420-7 and an edge detection circuit 430. In the present embodiment, for simplification, the digital phase detector is configured such that the number of input signal phases=the number of samplers 420=8. However, of course, these numbers may be generalized to N. Moreover, in the present embodiment, the number of input signal phases=the number of samplers=420. However, these numbers may differ.

Samplers 420-0, 420-1, . . . , and 420-7 are typically D flip-flops or similar elements. A reference signal Ref is supplied to a clock terminal of each of samplers 420-0, 420-1, . . . , and 420-7. Input signals CKV₀, CKV₁, . . . , and CKV₇ are supplied to D terminals of samplers 420-0, 420-1, . . . , and 420-7, respectively. That is, samplers 420-0, 420-1, . . . , and 420-7 sample input signals CKV₀, CKV₁, . . . , and CKV₇ in accordance with the reference signal Ref. Samplers 420-0, 420-1, . . . , and 420-7 then output input signals CKV₀, CKV₁, . . . , and CKV₇ to the edge detection circuit 430 through a Q terminal. Samplers 420-0, 420-1, . . . , and 420-7 may sample differential input signals or may be driven by differential clock signals.

The edge detection circuit 430 detects time difference between the rising edge of the reference signal Ref and the rising edge of input signal CKV₀ preceding the rising edge of the reference signal Ref based on an input signal sequence, and Q_{c0}Q_{c1}, . . . , and Q_{c7} from samplers 420-0, 420-1, . . . , and 420-7. The edge detection circuit 430 then outputs the digital signal DTriseC indicative of the detected time difference. Specifically, the edge detection circuit 430 may detect the time difference similarly to the edge detection and normalization circuit 300. The time resolution of the CTDC 410 is equal to Tv/8.

The FTDC 440 includes M samplers 450-0, 450-1, . . . , and 450-(M−1), M delay devices 460-0, 460-1, . . . , and 460-(M−1), and an edge detection circuit 470. In the present embodiment, M is an integral multiple of 8. Provided that the number of input signal phases is generalized to N, M is an integral multiple of N. Furthermore, in the present embodiment, samplers 450-0, 450-1, . . . , and 450-(M−1) are sometimes collectively referred to as a sampler group 450.

The M delay devices 460-0, 460-1, . . . , 460-(M−1) are typically selectors. The M delay devices 460-0, 460-1, . . . , and 460-(M−1) each select one of two input signals in accordance with selection control signals S₀, S₁, . . . , S_{M-1}, respectively. Then, each of the M delay devices 460-0, 460-1, . . . , and 460-(M−1) delays the selected signal by substantially t2 and then supplies the delayed signal to the next stage. In the following description, for simplification, a delay device 460-m selects an output signal Rₘ₋₁ (or R_{M-1} when m=0) from the preceding stage if the selection control signal Sm is 0. The delay device 460-m selects the reference signal Ref if the selection control signal Sm is 1. In the present embodiment, m is any integer of at least 0 and at most M−1.

One of the selection control signals S₀, S₁, . . . , and S_{M-1} is set to 1, and the remaining M−1 selection control signals are set to 0. In the following description, S_{K}=1 (K is an integer of at least 0 and at most M−1). That is, output signal R_{M-1} from the delay device 460-(M−1) lags behind an output signal R_{K} from the delay device 460-K in time by substantially (M-K−1)·t2. In the following description, the time difference between the reference signal Ref and output signal R_{K} from the delay device 460-K is neglected for simplification. Furthermore, an output signal R_{K-1} from the delay device 460-(K−1) (or output signal R_{M-1} from the delay device 460-(M−1) when K=0) lags behind output signal R_{K} from the delay device 460-K in time by substantially (M−1)·t2. The digital phase detector is designed such that t2 and Tv/8 differ. However, which of these values is greater or smaller does not matter.

Samplers 450-0, 450-1, . . . , and 450-(M−1) are typically D flip-flops or similar elements. An output signal Rₘ from a delay device 460-m is supplied to a clock terminal of a sampler 450-m. An input signal CKV_{mmod8} is supplied to a D terminal of sampler 450-m. That is, sampler 450-m samples input signal CKV_{mmod8} in accordance with output signal Rₘ, from the delay device 460-m. Sampler 450-m then outputs input signal CKV_{mmod8} to the edge detection circuit 470 through a Q terminal. Sampler group 450 may sample differential input signals or may be driven by differential clock signals.

The edge detection circuit 470 detects the time difference between the rising edge of the reference signal Ref and the rising edge of a specified input signal preceding the rising edge of the reference signal Ref based on an input signal sequence Q_{fQ}, Qᵣ₁, . . . , and Q_{f(M-1)} from sampler group 450. The edge detection circuit 470 then outputs the digital signal DTriseF indicative of the detected time difference. The specified input signal lags behind input signal CKV₀ in time by K·Tv/8. In other words, the specified input signal is an input signal CVK_{Kmod8} sampled by a sampler 450-K.

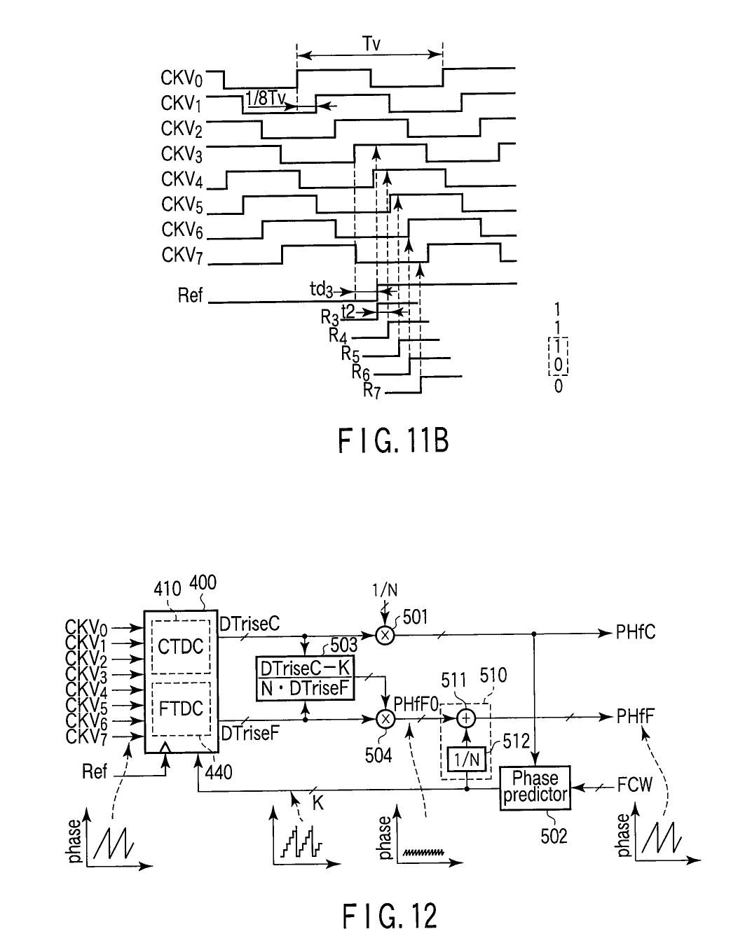

FIG. 11A illustrates detection of the time difference for K=1. FIG. 11B illustrates detection of the time difference for K=3. In each of the examples illustrated in FIG. 11A and FIG. 11B, Tv/8>t2.

In the example illustrated in FIG. 11A, the edge detection circuit 470 analyzes a position in the input signal sequence where 1 changes to 0 (the position is located between R₁₀ and R₁₁) to detect a time difference td₀. Time difference td₀ is indicative of the time difference between the rising edge of input signal CKV₀ and the rising edge of the reference signal Ref.

In the example illustrated in FIG. 11B, the edge detection circuit 470 analyzes a position (located between R₅ and R₆) in the input signal sequence where 1 changes to 0 to detect a time difference td₃. Time difference td₃ is indicative of the time difference between the rising edge of input signal CKV₃ and the rising edge of the reference signal Ref.

As is apparent from FIG. 11A and FIG. 11B, the time difference detected by the edge detection circuit 470 varies depending on the value of K. That is, K of an appropriate value enables a reduction in the number of input signal sequences required to detect a time difference td_{K}. In other words, the edge detection circuit 470 may detect a smaller time difference td_{K} regardless of the value of time difference td₀. Thus, the TDC in FIG. 10 enables a reduction in the numbers of the delay devices 460 and samplers 450 required to detect the time difference, compared to the configuration that detects time difference td₀. The difference K·Tv/8 between time difference td₀ and time difference td_{K} has a known value. Hence, time difference td0 can be reconstructed by adding the difference K·Tv/8 to time difference td_{K}.

As described above, sampler group 450 samples input signals lagging behind one another in time by Tv/8 in accordance with clock signals lagging behind one another in time by t2. That is, the FTDC 440 in FIG. 10 achieves operations similar to those of a VDL. Hence, the time resolution of the FTDC 440 in FIG. 10 is equal to the difference between unit delay Tv/8 of the input signal and unit delay t2 of the reference signal Ref.

FIG. 12 illustrates a digital phase detector including the TDC according to the present embodiment. The digital phase detector in FIG. 12 includes the TDC 400 according to the present embodiment, a multiplier 501, a phase predictor 502, a period calculation circuit 503, a multiplier 504, and a corrector 510.

The multiplier 501 multiplies output signal DTriseC from the CTDC 410 by the inverse of the value Tv_{C} (=N) of the period Tv of the input signal quantized by the time resolution (=Tv/N) of the CTDC 410. That is, the multiplier 501 multiplies output signal DTriseC from the CTDC 410 by the inverse of the number of input signal phases to convert the time difference into a phase difference. In the present embodiment, the number of input signal phases=8 by way of example. However, the number of input signal phases can be generalized to N. An output signal PHfC from the multiplier 501 is output to an external component (for example, to a component in a digital phase-locked loop). Output signal PHfC from the multiplier 501 is also output to the phase predictor 502.

The phase predictor 502 predicts the phase of the input signal (for example, CKV₀) during the next period of the reference signal Ref based on output signal PHfC from the multiplier 501 and an external frequency control word FCW. Based on the result of the prediction, the phase predictor 502 determines the value of K resulting in S_{K}=1.

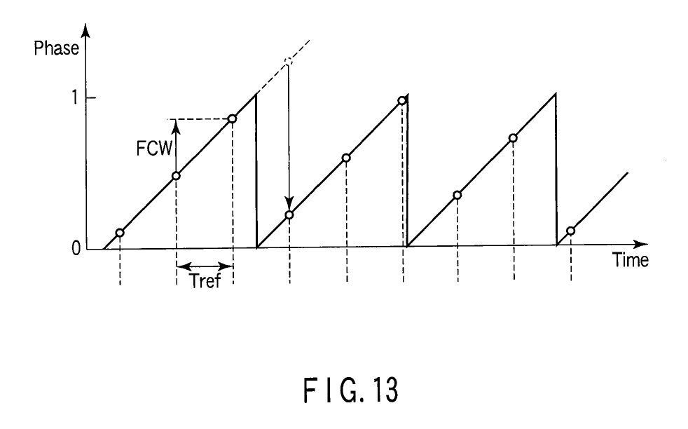

By way of example, it is assumed that a digital phase-locked loop (not shown in the drawings) including the digital phase detector in FIG. 12 is locked. Under such conditions, as illustrated in FIG. 13, the phase of the input signal increases by FCW for every period Tref of the reference signal Ref. That is, the phase predictor 502 can predict the phase of the input signal during the next period of the reference signal Ref by extracting the fractional portion of the sum of output signal PHfC from the multiplier 501 and the frequency control word FCW.

Conversion of the time difference indicated by output signal DTriseF from the FTDC 440 into a phase difference requires the value Tv_{F} of the period Tv of the input signal quantized by the time resolution of the FTDC 440 (=|Tv/N-−t2|). However, the input range of the FTDC 440 is too narrow to allow the quantized value Tv_{F} to be directly derived.

Thus, the period calculation circuit 503 calculates the quantized value Tv_{F} as follows. Output signal DTriseF from the FTDC 440 is indicative of the value of time difference td_{K} quantized by the time resolution of FTDC 440. Output signal DTriseC from the CTDC 410 is indicative of the value of time difference td₀ quantized by the time resolution of CTDC 410. Here, the value of DTriseC minus K expresses the same as the value of DTriseF. That is, DTriseF/(DTriseC−K) corresponds to a ratio used to convert the quantized value obtained by the CTDC 410 into the quantized value obtained by the FTDC 440. Multiplying Tv_{C} (=N) by this ratio allows Tv_{F} (=N·DTriseF/(DTriseC−K)) to be derived. The period calculation circuit 503 inputs the inverse of Tv_{F} to the multiplier 504. The multiplier 504 multiplies output signal DTriseF from the FTDC 440 by the inverse of Tv_{F} from the period calculation circuit 503 to convert the time difference into a phase difference. The multiplier 504 input a signal PHdF0 indicative of the phase difference to the corrector 510.

The signal PHfF0 is indicative of the phase difference between CKV_{Kmmod8} and the reference signal Ref. The corrector 510 corrects the signal PHfF0 and outputs a signal PHfF indicative of the phase difference between CKV0 and the reference signal Ref. The corrector 510 includes an adder 511 and a multiplier 512. The multiplier 512 multiplies K from the phase predictor 502 by the inverse of the number of input signal phases. The multiplier 512 thus calculates the amount of phase shift between input signal CKV₀ and input signal CKV_{Kmod8}. The adder 511 adds the result of the multiplication by the multiplier 512 to PHfF0 to reconstruct the phase difference between CKV₀ and the reference signal Ref.

As described above, the TDC according to the eight embodiment selects one of the input signals and detects the time difference between the edge of the selected input signal and the edge of the reference signal. Thus, by selecting an input signal with a small phase difference from the reference signal, the TDC according to the present embodiment enables a reduction in the numbers of the delay devices and samplers required to detect the time difference.

### Ninth Embodiment

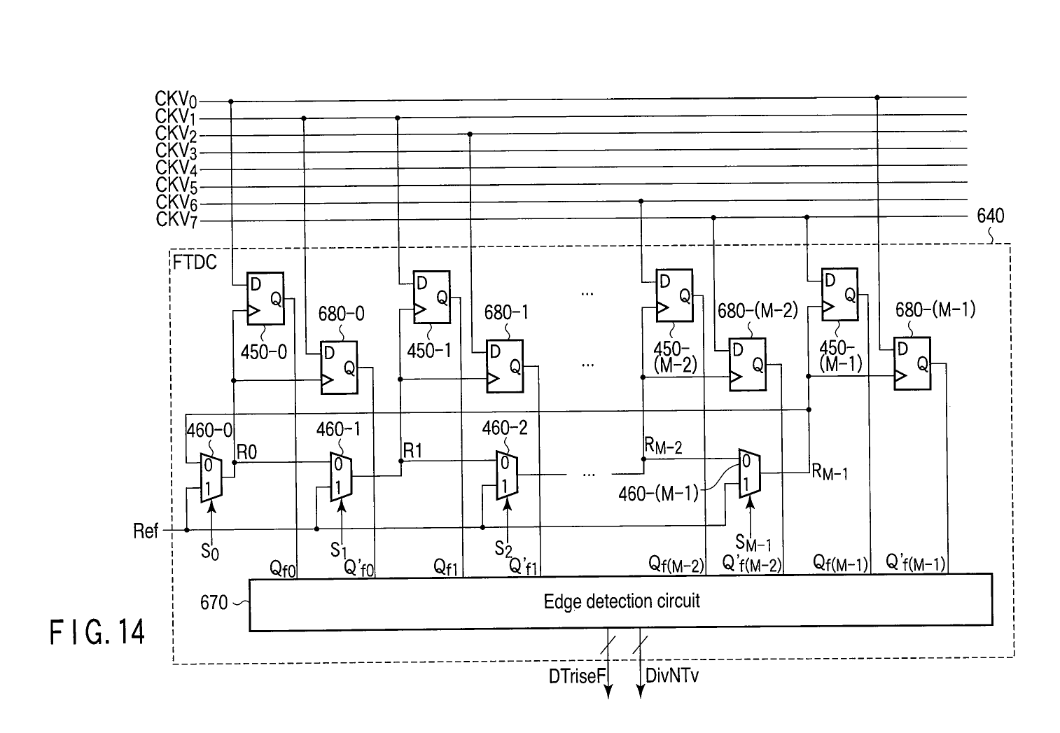

A TDC according to a ninth embodiment corresponds to the TDC in FIG. 10 in which the FTDC 440 is replaced with an FTDC 640 shown in FIG. 14. The FTDC 640 includes M samplers 450-0, 450-1, . . . , and 450-(M−1), M samplers 680-0, 680-1, . . . , 680-(M−1), M delay devices 460-0, 460-1, . . . , and 460-(M−1), and an edge detection circuit 670. In the present embodiment, the M samplers 450-0, 450-1, . . , and 450-(M−1) are sometimes collectively referred to as a first sampler group 450, and the M samplers 680-0, 680-1, . . . , 680-(M−1) are sometimes collectively referred to as a second sampler group 680.

Samplers 680-0, 680-1, . . . , and 680-(M−1) are typically D flip-flops or similar elements. An output signal Rₘ from a delay device 460-m is supplied to a clock terminal of a sampler 680-m. An input signal CKV_{(m+1)mod8} is supplied to a D terminal of sampler 680-m. That is, sampler 680-m samples the input signal lagging behind a signal from a sampler 450-m by one phase in accordance with the same clock signal as that for sampler 450-m. Sampler 680-m then outputs the input signal to the edge detection circuit 670 through a Q terminal. The second sampler group 680 may sample differential input signals or may be driven by differential clock signals.

Like the edge detection circuit 470, the edge detection circuit 670 detects time difference td_{K} between the rising edge of the reference signal Ref and the rising edge of an input signal CKV_{Kmod8} preceding the rising edge of the reference signal Ref based on an input signal sequence Q_{f0}, Q_{f1}, . . . , and Q_{f(M-1)} from the first sampler group 450. The edge detection circuit 670 then outputs the digital signal DTriseF indicative of the detected time difference.

Moreover, the edge detection circuit 670 detects time difference td_{K+1} between the rising edge of the reference signal Ref and the rising edge of an input signal CKV_{(K+1)mod8} preceding the rising edge of the reference signal Ref based on an input signal sequence Q′_{f0}, Q′_{f1}, . . . , and Q′_{f(M-1)} from the second sampler group 680. The edge detection circuit 670 then outputs a digital signal DivNTv indicative of the difference between time difference td_{K+1} and time difference td_{K}. The digital signal DivNTv is the value of the time difference between the rising edge of input signal CKV_{Kmod8} and the rising edge of input signal CKV_{(K+1)mod8} , quantized by the time resolution of the FTDC 640 (|Tv/8−t2|). That is, Tv_{F} can be derived by multiplying the digital signal DivNTv by the number of input signal phases (in this example, 8).

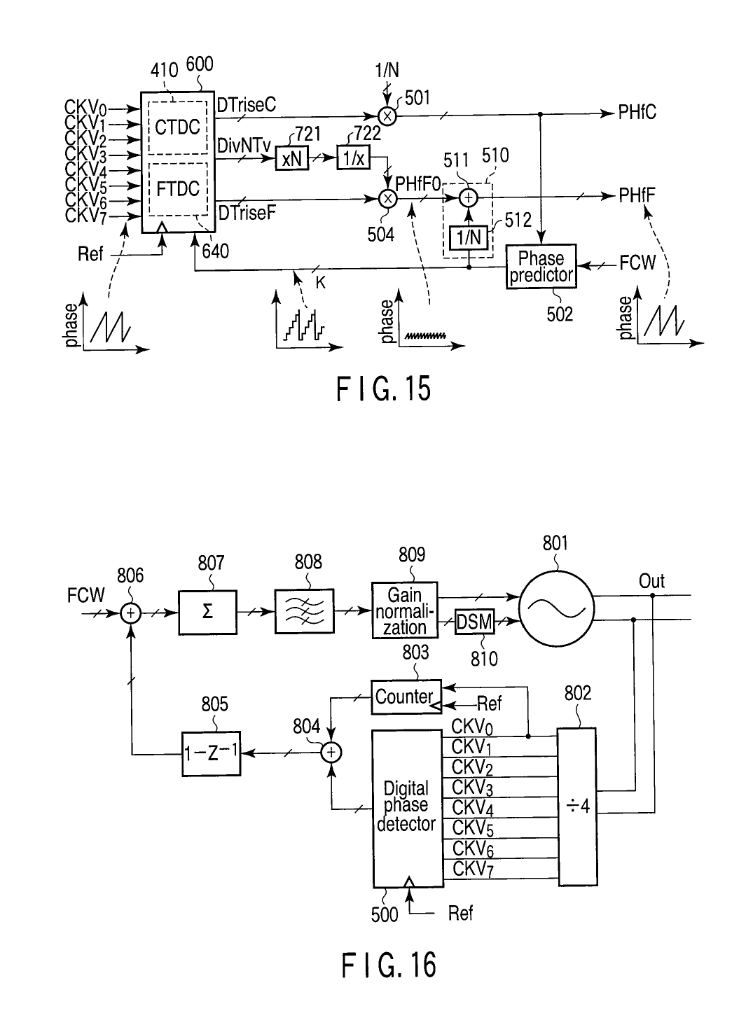

FIG. 15 illustrates a digital phase detector including a TDC according to the present embodiment. The digital phase detector in FIG. 15 includes a TDC 600 according to the present embodiment, a multiplier 501, a phase predictor 502, a multiplier 721, an inverse converter 722, a multiplier 504, and a corrector 510.

The multiplier 721 multiplies output signal DivNTv from the FTDC 640 by the number of input signal phases to derive Tv_{F}. The inverse converter 722 supplies the multiplier 504 with the inverse of Tv_{F} from the multiplier 721.

As described above, the TDC according to the present embodiment further detects the value of the time difference between the adjacent input signal phases quantized by the time resolution of the FTDC. Thus, the TDC according to the present embodiment allows easy derivation of the value of the period of the input signal quantized by the time resolution of the FTDC (without the need for a division process).

### Tenth Embodiment

As shown in FIG. 16, a digital phase-locked loop according to a tenth embodiment includes a digital phase detector 500 according to each of the above-described embodiments. More specifically, the digital phase-locked loop in FIG. 16 includes a digital phase detector 500, a digitally controlled oscillator 801, a frequency divider 802, a counter 803, an adder 804, a differentiator 805, a comparator 806, an integrator 807, a loop filter 808, a gain normalization circuit 809, and a delta-signal modulator 810.

The digitally controlled oscillator 801 is configured such that the frequency of an oscillation signal from the digitally controlled oscillator 801 is discretely controlled by a gain normalization circuit 809 and a delta-sigma modulator 810. The oscillation signal from the digitally controlled oscillator 801 is provided as an output signal and input to the frequency divider 802.

The frequency divider 802 divides the frequency of the differential oscillation signal from the digitally controlled oscillator 801 by 4 to obtain 8-phase signals CKV₀, . . , and CKV₇. The 8-phase signals CKV₀, . . . , and CKV₇ are input to the digital phase detector 500. Moreover, any one of the 8-phase signals CKV₀, . . . , and CKV₇ (for example, CKV₀) is input to the counter 803.

The digital phase detector 500 outputs a digital signal Phf indicative of the phase difference between any of the input signals (for example, CKV₀) and the reference signal Ref. The counter 803 utilizes the reference signal Ref as a clock to count the number of periods of the input signal (for example, CKV₀)

The adder 804 adds an output signal from the counter 803 and the output signal from the digital phase detector 500 together to obtain phase information on input signal CKV₀. The output signal from the counter 803 is indicative of the integer portion of the phase information on input signal CKV₀. The output information from the digital phase detector 500 is indicative of the fractional portion of the phase information on input signal CKV₀.

The differentiator 805 differentiates the phase information on input signal CKV₀ from the adder 804 to obtain frequency information on input signal CKV₀. The comparator 806 compares a desired frequency control word FCW with the frequency information on input signal CKV₀ from the differentiator 805 to detect frequency error information on input signal CKV₀.

The integrator 807 integrates the frequency error information on input signal CKV₀ from the comparator 806 to obtain phase error information on input signal CKV₀. The loop filter 808 filters the phase error information from the integrator 807.

The gain normalization circuit 809 generates a gain adjustment signal used to adjust a loop gain based on an output signal from the loop filter 808. The delta-sigma modulator 810 carries out delta-sigma modulation on lower bits of the gain adjustment signal to generate a control signal for the digital control oscillator 801.

As described above, the digital phase-locked loop according to the tenth embodiment includes the digital phase detector according to each of the above-described embodiments. Thus, the digital phase-locked loop according to the present embodiment provides effects similar to those of each of the above-described embodiments.

The digital phase-locked loop in FIG. 16 is illustrative. The digital phase-locked loop according to the present embodiment may include components not shown in FIG. 16 or omit some of the components shown in FIG. 16.

### Eleventh Embodiment

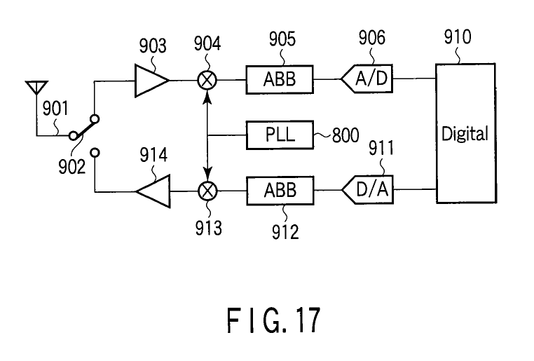

As shown in FIG. 17, a communication apparatus according to an eleventh embodiment includes the digital phase-locked loop 800 according to the tenth embodiment. More specifically, the communication apparatus in FIG. 17 includes the digital phase-locked loop 800, an antenna 901, a switch 902, LNA 903, a mixer 904, analog baseband circuit (ABB) 905, analog-to-digital converter (ADC) 906, a digital signal processing unit 910, digital-to-analog converter (DAC) 911, ABB 912, a mixer 913, and power amplifier (PA) 914.

A reception signal in a carrier frequency band received by the antenna 901 is supplied to the LNA 903 via the switch 902. The LNA 903 amplifies the signal level of the input signal and then supplies the amplified signal to the mixer 904. The mixer 904 multiplies an output signal from the LNA 903 by a local oscillation signal generated by the digital phase-locked loop 800 (that is, a local oscillator) to obtain a baseband reception signal (downconversion).

ABB 905 carries out various baseband processes such as a filtering process on a baseband reception signal from the mixer 904. ABB 905 then inputs the processed signal to the ADC 906. The ADC 906 converts the output signal from ABB 905 into a digital domain and then inputs the converted signal to the digital signal processing unit 910. The digital signal processing unit 910 carries out various processes on reception data and transmission data.

The DAC 911 converts an input signal from the digital signal processing unit 910 into an analog domain, and then inputs the converted signal to ABB 912. ABB 912 carries out various baseband processes such as amplification and a filtering process on the analog signal from the DAC 911, and then inputs the processed signal to the mixer 913.

The mixer 913 multiplies the output signal from ABB 912 by the local oscillation signal generated by the digital phase-locked loop 800 to obtain a transmission signal in the carrier frequency band (upconversion). PA 914 amplifies the power of the transmission signal in the carrier frequency band from the mixer 913. PA 914 then supplies the amplified signal to the antenna 901 via the switch 902. The antenna 901 radiates the supplied transmission signal to a space.

The communication apparatus in FIG. 17 is illustrative. The communication apparatus according to the present embodiment may include components not shown in FIG. 17 or omit some of the components shown in FIG. 17. Furthermore, the communication apparatus in FIG. 17 can perform both transmission and reception. However, the digital phase-locked loop according to the tenth embodiment is applicable either to a communication apparatus dedicated to transmission (that is, a transmitter) or to a communication apparatus dedicated to reception (that is, a receiver).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A digital phase detector comprising:
a chain of delay devices configured to receive a reference signal through a first stage and delay the reference signal at each stage;
a sampler group configured to include a first sampler samples a first signal of N-phase input signals (N is an integer of at least 2) in accordance with the reference signal and a second sampler samples a second signal of N-phase input signals which lags behind the first signal in phase by 2π/N in accordance with an output signal from the first stage of the chain of delay devices; and
a detection circuit configured to detect a time difference between an edge of the reference signal and an edge of the first signal based on sampled signals from the sampler group and to convert the time difference into a phase difference.

2. The phase detector according to claim 1, wherein N is an even number,
the first sampler samples a first differential signal between the first signal and a reverse-phase signal of the first signal included in the N-phase input signals, and
the second sampler samples a second differential signal between the second signal and a reverse-phase signal of the second signal included in the N-phase input signals.

3. The phase detector according to claim 1, wherein
the chain of delay devices includes at least N delay devices,
the sampler group includes a third sampler configured to sample the first signal in accordance with an output signal from an Nth stage of the chain of delay devices, and
a total number of samplers included in the sampler group is greater than N.

4. A digital phase detector comprising:
an L-phase (L is an integer of at least 2) ring oscillator configured to utilize a reference signal as a trigger;
a sampler group configured to include a first sampler samples a first signal of N-phase input signals (N is a divisor of L) in accordance with a signal included in L-phase oscillation signals from the ring oscillator and having a most leading phase and a second sampler samples a second signal of N-phase input signals lagging behind the first signal by 2π/N, in accordance with a signal included in the L-phase oscillation signals and having a second most leading phase; and
a detection circuit configured to detect a time difference between an edge of the reference signal and an edge of the first signal based on sampled signals from the sampler group to convert the time difference into a phase difference.

5. The phase detector according to claim 4, wherein L is greater than N,
the sampler group includes a third sampler configured to sample the first signal in accordance with a signal included in the L-phase oscillation signals and having an (N+1)th most leading phase, and
a total number of samplers included in the sampler group is greater than N.

6. A digital phase detector comprising:
a first time-to-digital converter configured to quantize a time difference between an edge of a reference signal and an edge of a first signal of N-phase input signals (N is an integer of at least 2) by a first time resolution corresponding to a time difference between adjacent phases of the N-phase input signals to obtain a first quantized value; and
a second time-to-digital converter configured to quantize a time difference between the edge of the reference signal and an edge of a second signal of the N-phase input signals lagging behind the first signal in phase by 2π·K/N (K is an integer of at least 0 and less than M and M is an integral multiple of N) by a second time resolution smaller than the time difference between the adjacent phases of the N-phase input signals to obtain a second quantized value, and
wherein the second time-to-digital converter comprises:
a chain of delay devices configured to include M-stage delay devices annularly connected together and to receive the reference signal through (K+1)th stage so that the reference signal is delayed at each stage;
a first sampler group configured to include a first sampler samples the second signal in accordance with an output signal from the (K+1)th stage of the chain of delay devices and a second sampler samples a third signal of N-phase input signals lagging behind the second signal in phase by 2π/N in accordance with an output signals from a stage following the (K+1)th stage of the chain of delay devices; and
a detection circuit configured to detect the time difference between the edge of the reference signal and the edge of the second signal based on sampled signals from the first sampler group and to obtain the second quantized value.

7. The phase detector according to claim 6, further comprising a phase predictor configured to predict a phase of the first signal during a following period of the reference signal based on a frequency control word used to set a desired frequency for the N-phase input signals and the first quantized value, and determine a value of K based on prediction result.

8. The phase detector according to claim 6, further comprising a calculation circuit configured to subtract K from the first quantized value, divide the second quantized value by a result of subtraction, and multiply a value of a period of the N-phase input signals quantized by the first time resolution, by a result of division to obtain a value of the period of the N-phase input signals quantized by the second time resolution.

9. The phase detector according to claim 6, wherein the second time-to-digital converter further comprises a second sampler group configured to include a third sampler configured to sample the third signal in accordance with the output signal from the (K+1)th stage of the chain of delay devices and a fourth sampler configured to sample a fourth signal of the N-phase input signals lagging behind the third signal in phase by 2π/N in accordance with the output signal from the stage following the (K+1)th stage of the chain of delay devices, and
the detection circuit further detects a time difference between an edge of the third signal and the edge of the reference signal based on sampled signals from the second sampler group, and obtains a third quantized value of a time difference between the edge of the second signal and the edge of the third signal quantized by the second time resolution.

10. A digital phase-locked loop comprising:
a digitally controlled oscillator configured such that a frequency of an oscillation signal from the digitally controlled oscillator is discretely controlled;
a frequency divider configured to divide a frequency of the oscillation signal to obtain the N-phase input signals;
the phase detector according to claim 1; and
a control circuit configured to estimate a phase error between the oscillation signal and a desired signal based on the phase difference and to control the oscillator.
